(19) United States
(12) Patent Application Publication
(10) Pub. No.: US 2017/0277348 A1
(43) Pub. Date: Sep. 28, 2017

(54) CAPACITIVE TOUCH SENSING SYSTEM WITH IMPROVED GUARDING SCHEME AND DEVICES EMPLOYING SAME

(71) Applicant: UICO, LLC, Elmhurst, IL (US)

(72) Inventors: Hiten S. Randhawa, Saratoga, CA (US); Jyotindra Shakya, Fremont, CA (US)

(21) Appl. No.: 15/081,463

(22) Filed: Mar. 25, 2016

(51) Int. Cl. G06F 3/041; G06F 3/044

(52) U.S. Cl. CPC G06F 3/0418; G06F 3/044; G06F 2203/04107

(57) ABSTRACT

A capacitive touch sensing system with improved guarding method employing square wave guarding signal applied to sensors adjacent to sensor of interest such that time-averaged value of signal added due to guarding is completely equal and opposite to the signal due to presence of mutual capacitance from the sensor of interest to adjacent sensors. A touch sensor device, processor with logic for effecting the method, and storage device for storing logic to effect the method are also disclosed.

### BACKGROUND

The present disclosure generally relates to capacitive touch sensing systems, and more particularly relates to methods of eliminating unwanted capacitances being sensed using a scheme called guarding.

Capacitive sensing systems usually consist of a capacitive sensor matrix and capacitive sensing devices implementing a specific capacitive sensing technique. One general type of capacitive sensor technology is projected capacitance (PCAP) technology, wherein electric field lines project beyond touchable surface. The projected field lines consist of two kinds of field lines: ones that terminate at adjacent sensors and ones that terminate at far away conducting surfaces in the environment, which are often grounded. The field lines that terminate at adjacent sensors are due to capacitance across sensor pairs, often called mutual capacitance and voltage applied across the sensors. The field lines that terminate at far away surfaces are due to inherent capacitance, often called self-capacitance, of a particular sensor and voltage applied to it with respect to the environment. Based on which of the two capacitance is sensed, there are two capacitance sensing techniques; one is called self-capacitance sensing and other called mutual-capacitance sensing.

A PCAP sensor with mutual capacitance sensing generally includes sensors arranged in rows and columns such that capacitance at each cross-point can be sensed. When the projected fields across two sensors are interrupted by an object such as a finger, there is change in capacitance across the sensors and it can be sensed as touch. A PCAP sensor with self-capacitance sensing generally includes sensors arranged in an arbitrary pattern covering an entire touchable area called a touch panel.

The mutual capacitance sensing technique is generally implemented such that various sensor capacitances distributed across the touch panel are sensed a row at a time. In such technique, by measuring charge transfer across two terminals of each sensor capacitor, it is possible to sense mutual capacitance explicitly. On the other hand, the self-capacitance sensing technique can be implemented to sense all the sensor capacitors at once in parallel or individually in a sequence. Sensing in a sequence reduces the cost of circuitry, and hence a device, implementing such sensing technique and is often desirable in touch panels with less sensors.

While it is possible to sense self-capacitance explicitly using parallel sensing, it is inherently impossible to sense only self-capacitance using sequential sensing. This inherent inability to isolate self-capacitance from total capacitance makes such sensing technique vulnerable to changes in mutual capacitance due to the presence of water and other conductive fluids on the touch panel. To overcome such shortcoming of sequential self-capacitance sensing technique, often additional schemes are employed to drive sensors adjacent to the sensor being sensed to emulate parallel sensing. Such additional schemes, which are an integral part of the sequential self-capacitance sensing technique is called guarding.

As detailed in U.S. Pat. Nos. 8,866,793 and 9,001,083, both of which are fully incorporated herein by reference to the extent permitted by law, the presence of water changes mutual capacitance and can greatly affect the reliability of overall touch sensing system. U.S. Pat. Nos. 8,866,793 and 9,001,083 address this problem by providing conductive structures proximate capacitive touch pads and a scheme for altering the electrical potential of the conductive structures to compensate for the effect of mutual capacitance, based on external conditions such as water or an intervening separator, e.g., a glove. The compensation for mutual capacitance improves the water immunity and therefore the reliability of the overall touch sensing system.

In the context of a touch sensing system with water immunity using sequential self-capacitance sensing, it is possible to reduce the resources needed such as analog to digital converters (ADCs) and signal conditioning circuitry called analog front end (AFE) by cycling through the sensors one at a time. However as stated before in doing so it becomes necessary to include a guarding scheme in order to drive identical waveforms or signals on adjacent sensors to avoid inclusion of mutual capacitance.

In the context of charge-transfer based sensing schemes such as drive voltage measured charge, it is necessary for the AFE to include a charge measuring circuit, which converts incoming signal in the form of charge into a voltage signal. One of the techniques for converting incoming charge into voltage uses a charge integrator circuit. In such an AFE, the input common mode of the integrator is set somewhere close to half the supply voltage to allow maximum voltage swing and to make design of such an circuit feasible. The voltage at which the touch sensors settle to during charge transfer phase is generally set to virtual ground which is generally half the supply voltage.

In FIGS. 1A to 1C, there are provided charts useful for explaining the effect of a lack of guarding. In FIG. 1A there is provided a chart of the output waveform V_{INT} of an integrator, when there is no guarding. In FIG. 1B, is a chart for a guarding signal waveform V_{GUARD}, which in this situation is non-existent. If FIG. 1C there is provided a chart in which is illustrated a typical sensing waveform V_{SENSE}, where an adjacent sensor is set to a constant voltage (V_{dd} in this case).

As can be seen, the sensing waveform has four phases: a charge phase φ1, a positive integration phase φ2, a discharge phase φ3, and a negative integration phase φ4, in that order.

In this example, the final voltage at the output V_{INT} of the integrator after one sensing cycle can be expressed as follows:

$$\begin{matrix}{V}_{INT} = \frac{0.5 * ( {Q}_{S} + {Q}_{M} ) - 0.5 * ( - {Q}_{S} - {Q}_{M} )}{{C}_{INT}} = \frac{{Q}_{S} + {Q}_{M}}{{C}_{INT}} & \\ where : & \\ {Q}_{S} = {C}_{S} {V}_{dd} \\ {Q}_{M} = ( {C}_{M} + {C}_{W} ) {V}_{dd} & \end{matrix}$$

In this relationship, C_{M} is the mutual capacitance due to an adjacent sensor or conductor, C_{S} is the sensor self-capacitance, and C_{W}, (as used throughout this specification) is capacitance introduced by the presence of a conductive liquid or gel, e.g., water. Similarly, Q_{S} is the charge due to self-capacitance of the sensor, while Q_{M} is the charge due to the mutual capacitance (which includes that introduced by the conductive liquid or gel). C_{INT} is a capacitance of the integrator.

In the relationship above, an internal reference factor of ½ or 50% is used as a convenient voltage for ease of implementing the integrator circuit design.

In the absence of guarding, the sensor output signal V_{SENSE} includes charge from mutual capacitance Q_{M}, which can change in the presence of the conductive liquid or gel, e.g., water. Again, the additional capacitance C_{W} represents this change or influence. This can lead to detecting the liquid or gel, e.g., water, as false touches.

For the purposes of this illustration, the sensor has a 1 pF capacitance, the integrating capacitor has a capacitance of 1 pF, the mutual capacitance is 0.1 pF and V_{dd} is 1V. The waveforms include 5 complete cycles, each cycle including a positive and a negative charge phase for the sensor. The effect of the mutual capacitance is assumed to be a charge of 0.5V and is reflected in the 0.5V bias of the sensor signal in FIG. 1C.

In FIG. 1C it can be seen the sense signal V_{SENSE} effectively immediately rises from 0.5V (due to charge from the mutual capacitance) to 1.0V and stays at 1.0V for the first ¼ of a cycle. This is the positive charging phase. For the second ¼ of the cycle, the sensor signal is returned to 0.5V, also referred to as the mid voltage. For the third ¼ of the cycle, the sensor is signal is set to 0.0V for the negative charging phase. Then, in the last ¼ of the cycle, the sensor signal is returned to 0.5V, again, also referred as the mid voltage.

In can be appreciated that in the absence of the charge Q_{M} from the mutual capacitance, the integrator output voltage V_{INT} should be 1V after one complete cycle and 5V after 5 cycles. However, since the charge Q_{M} from the mutual capacitance also gets integrated, it can be seen that the final integrator output voltage calculates to 5.5V instead of 5V.

However, although using a guarding signal identical to the sensor of interest driving signal should completely eliminate the charge Q_{M}, it introduces other problems. Since such a waveform needs to be driven to a middle voltage other than Vdd or ground, it is not possible to do so using digital drivers. To remedy this problem, some systems have used a replica circuit inside the sensor driving chip to generate the identical guarding waveform, which is then driven on the adjacent sensors. An example of such replica circuit can be found in Cypress Semiconductor, Inc.'s programmable system on a chip (PSoC®) CapSense™ based sensing system, where there is a copy of a sigma-delta converter just to derive the identical waveform. However such a technique is wasteful in terms of requiring additional analog circuitry.

On the other hand, if adjacent sensors or conductors are driven with a digital signal swinging from Vdd to ground, it will result in over-guarding. In this case, given all of the same parameters above, the integrator output voltage calculates to 4.5V, which is due to twice as much signal being subtracted as compared to that inherently present due to presence of the mutual capacitance C_{M}. In the over-guarding case, the relationship for the integrator voltage becomes:

$${V}_{INT} = \frac{0.5 * ( {Q}_{S} + {Q}_{M} ) - {Q}_{M} - ( 0.5 * ( - {Q}_{S} - {Q}_{M} ) + {Q}_{M} )}{{C}_{INT}} = \frac{{Q}_{S} - {Q}_{M}}{{C}_{INT}}$$

It can be appreciated that this outcome still depends on the charge Q_{M} which includes the capacitance C_{W} and hence the presence of a conductive liquid or gel, e.g., water.

In FIGS. 2A to 2C, there are provided another set of signal charts to explain this effect of over-guarding. In FIG. 2A, a chart of the output V_{INT} of the integrator is illustrated. In FIG. 2B a chart of a guard signal waveform V_{GUARD} is illustrated. In FIG. 2C, the sensor signal V_{SENSE} with a 0.5v charge due to capacitance C_{M} is again illustrated for ease of understanding.

As can be seen in FIG. 2A, the final integrator output voltage V_{INT} in the over-guarding situation is only 4.5v, again due to twice as much signal being subtracted as compared to that inherently present due to presence of mutual capacitance.

In FIGS. 2B and 2C, the overguarding can be seen because the rising edge of the guard signal V_{GUARD} occurs well before a positive charge phase of a subsequent cycle, and after the negative charge phase of a of a prior cycle. That is to say, the rising edge does not occur during a negative charge phase of the prior cycle. Additionally, a falling edge of the guard signal VGUARD occurs after the positive charge phase of a prior cycle, but prior to the negative charge phase of that cycle.

Another way to look at it, both transitions of the guard signal occur when the sensor signal V_{SENSE} is at mid voltage.

### SUMMARY

The present disclosure provides one or more inventions in which a digital guarding scheme is used to eliminate integration of undesired mutual capacitance.

In an embodiment, there is provided a digital guard waveform that is used to drive a conductive element adjacent a capacitive sensor of interest in a manner such that a time averaged value of additional charge due to guarding of the adjacent conductive element is equal and opposite to that added due to the presence of mutual capacitance due to that conductive element. This allows for the use of a simple digital guarding scheme while achieving near perfect, if not perfect, guarding at the same time.

In an embodiment, there is provided a method of driving a capacitive touch sensing system, comprising: generating a guard waveform; during a sensing cycle, guarding a capacitive sensor of interest by applying the guard waveform to at least one conductive element adjacent to the capacitive sensor of interest; and integrating a voltage of the capacitive sensor of interest during the sensing cycle, wherein, a time averaged value of additional charge due to the guarding of the adjacent capacitive sensor is equal and opposite to that charge added due to the presence of mutual capacitance between capacitive sensor of interest and the adjacent capacitive sensor.

In an embodiment the adjacent conductive element is another capacitive sensor.

In an embodiment, the sensor of interest is only guarded once per sensing cycle. The guard signal transitions are occur in such a way that only one edge of the guard signal, be it a rising edge or a falling edge, lies within the time when sensor is at mid voltage. Hence only one transition of the guard signal is effective.

In an embodiment, the integrator output V_{INT} adheres to the following relationship:

$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$

where,

the internal reference is B (which is a percentage of V_{dd}), and A is 1-B,

Q_{S}=C_{S}V_{dd}, and

Q_{M}=(C_{M}+C_{W})V_{dd}.

Again, C_{M} is the mutual capacitance due to an adjacent sensor or conductor, C_{S} is the sensor capacitance, and C_{W}, (as used throughout this specification) is capacitance introduced by the presence of a conductive liquid or gel, e.g., water. Similarly, Q_{S} is the charge from the sensor, while Q_{M} is the charge from the mutual capacitance (which includes that introduced by the conductive liquid or ge). C_{INT} is a capacitance of the integrator.

In an embodiment, the integrator output V_{INT} adheres to the following relationship, given an internal reference factor of ½:

$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$

In an embodiment, a processor device includes logic that effects driving of a capacitive sensor device such that a sensor of interest is only guarded during a positive charge phase and a rising edge of a guard waveform is positioned during charge time of the sensor of interest, when the sensor of interest is not connected to an integrator.

In an embodiment, the processor device logic effects driving of the capacitive sensor device such that an integrator output V_{INT} adheres to the following relationship, given an internal reference factor of ½:

$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$

In an embodiment, the processor device logic effects driving of the capacitive sensor device such that an integrator output V_{INT} adheres to the following relationship:

$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}} ,$$

where the internal reference is B (which is a percentage of V_{dd}), and A is 1-B.

In an embodiment, a non-transitory storage device includes machine readable or implementable logical instructions that when executed by the machine cause the machine to effect of a capacitive sensor such that a sensor of interest is only guarded during a positive charge phase and a rising edge of a guard waveform is positioned during charge time of the sensor of interest, when the sensor of interest is not connected to an integrator.

In an embodiment, the logical instructions effect driving of the capacitive sensor such that an integrator output V_{INT} adheres to the following relationship, given an internal reference factor of ½:

$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$

In an embodiment, the logical instructions effect driving of the capacitive sensor such that an integrator output V_{INT} adheres to the following relationship:

$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}} ,$$

where the internal reference factor is B (which is a percentage of V_{dd}), and A is 1-B.

These and other aspects and features of the disclosed embodiments are described in greater detail below with reference to the accompanying drawings.

### BRIEF DESCRIPTION OF THE DRAWINGS

The accompanying drawings constitute a part of this specification and illustrate an embodiment of the invention and together with the specification, explain the invention.

FIGS. 1A to 1C are charts illustrating the effect of a lack of guarding during integration of a sensor signal. FIG. 1A is a chart illustrating a typical integrator output waveform. FIG. 1B is a chart illustrating a lack of a guard signal waveform. FIG. 1C is a chart illustrating a typical sensing signal waverform.

FIGS. 2A to 2C are charts illustrating the effect of a over guarding during integration of a sensor signal. FIG. 2A is a chart illustrating a typical integrator output waveform. FIG. 2B is a chart illustrating a typical guard signal waveform. FIG. 2C is a chart illustrating a typical sensing signal waverform.

FIGS. 3A to 3C are charts illustrating the effect of guarding during integration of a sensor signal using principles disclosed herein. FIG. 3A is a chart illustrating an integrator output waveform when a guard signal using principles disclosed herein is employed. FIG. 3B is a chart illustrating a guard signal waveform using principles disclosed herein. FIG. 3C is a chart illustrating a sensing signal waveform.

FIGS. 4A and 4B illustrate a display with a touch screen that can be driven in accordance with principles disclosed herein.

FIG. 5A-5C illustrate different keypads with touch sensing surfaces that can be driven in accordance with principles disclosed herein.

FIG. 6 illustrates a processor device in which principles of the disclosure can be implemented.

FIG. 7 illustrates a matrix of sensors that can be driven in accordance with principles disclosed herein

FIG. 8 illustrates a matrix of sensors with additional guarding elements that can be driven in accordance with principles disclosed herein.

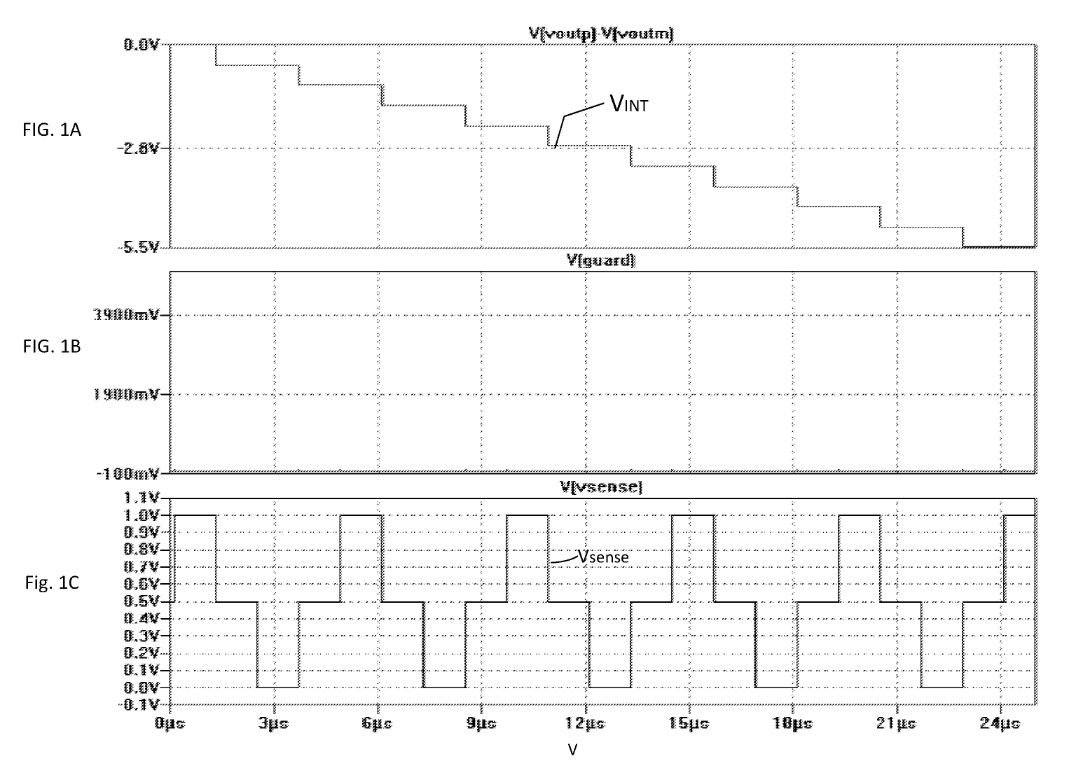

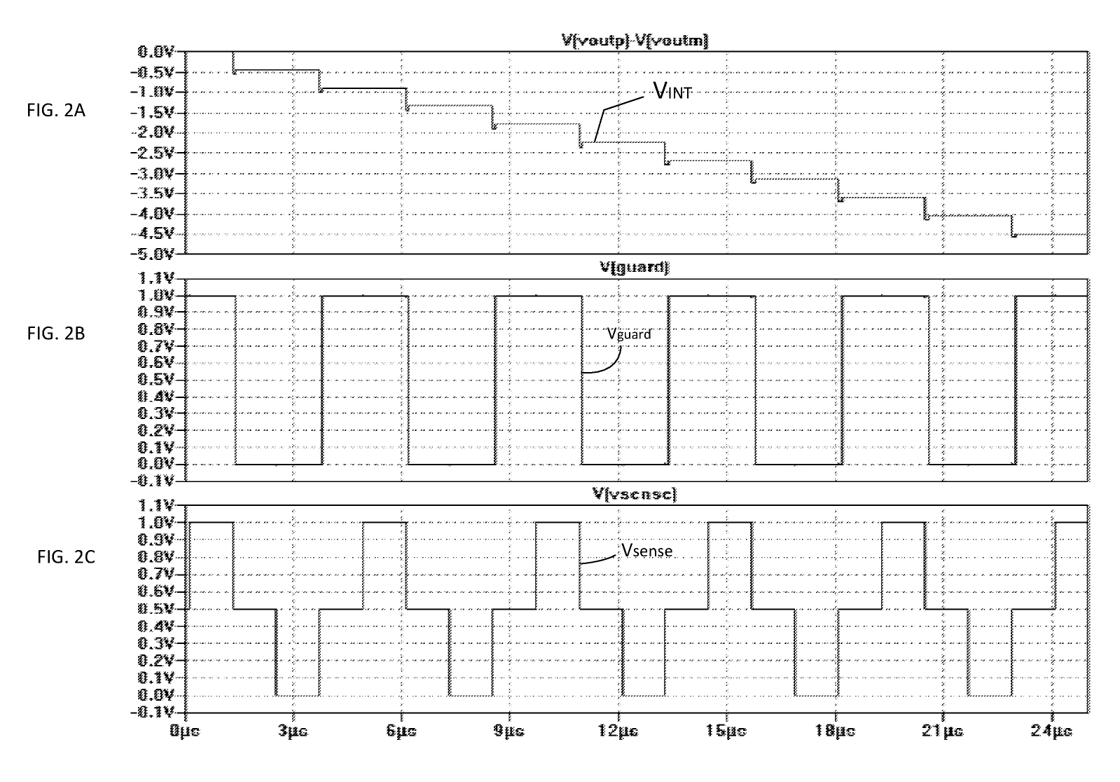

### DETAILED DESCRIPTION OF THE PRESENTLY PREFERRED EMBODIMENTS

The present disclosure is herein described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. One skilled in the art recognizes that numerous alternative components and embodiments may be substituted for the particular examples described herein and still fall within the scope of the invention.

Embodiments of the present disclosure provides a new or improved guarding method and devices using same for capacitive touch sensor systems in which the capacitive influence of a conductive liquid or gel, e.g., water, can be eliminated or minimized.

In this improved guarding method one or more conductive elements adjacent, i.e., nearest neighbor to, a sensor element of interest are driven with a guard signal. The conductive elements may themselves be another capacitive sensor element.

In this improved guarding scheme, it is preferable to utilize the correct polarity and timing of the guard signal with respect to the sensing waveform. This is done by, essentially, guarding only during a portion of the driving time of a capacitive sensor device, preferably half of the time, such that a sensor of interest is only guarded during a positive charge phase. To that end, the guard signal transitions are positioned in such a way that only one of the edges of the guard signal waveform lies within the time when the sensor is at mid voltage. Hence only one of the guard signal transitions is effective for guarding.

Preferably, a rising edge of a guard waveform is positioned during charge time of the sensor of interest, when the sensor of interest is not connected to an integrator.

The effective expression for the final voltage output at the integrator, given an internal reference factor of 50% or ½ of V_{dd}, is then:

$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$

The relationships noted above still hold, namely Q_{S}=C_{S} V_{dd} and Q_{M}=(C_{M}+C_{W})V_{dd}.

Further, C_{M} is the mutual capacitance due to an adjacent sensor or conductor, C_{S} is the sensor capacitance, and C_{W}, (as used throughout this specification) is capacitance introduced by the presence of a conductive liquid or gel, e.g., water. Similarly, Q_{S} is the charge from the sensor, while Q_{M} is the charge from the mutual capacitance (which includes that introduced by the conductive liquid or ge). C_{INT} is a capacitance of the integrator

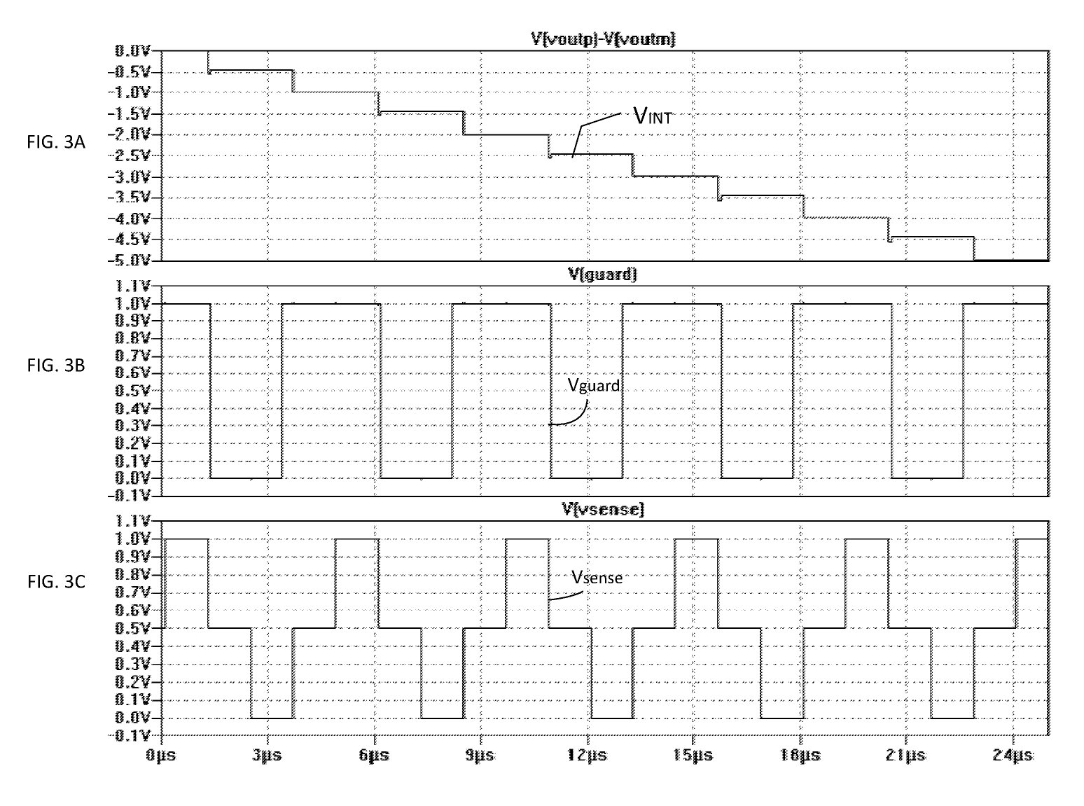

Hence although there may be over-guarding during the positive charge phase, by the end of first cycle, all of the charge coming from mutual capacitance is subtracted and the integrator output signal V_{INT} will not depend on the presence of a conductive liquid or gel, e.g., water. As one can see in the waveform of FIG. 3A, the final integrator voltage V_{INT} correctly calculates to 5V at the end of 5 complete cycles, which is exactly equal to the expected value if charge from sensor alone is integrated.

Comparing FIGS. 3B and 3C, it can be seen how only one transition, i.e., a rising or falling edge of the guard signal V_{GUARD} occurs when the sense signal V_{SENSE} is at mid voltage. The other transition, typically rising edge, falls in the negative charge phase of a cycle.

Additionally, the scheme disclosed herein can be used where the internal reference voltage is not exactly 50% of the supply voltage. In such case, the voltage expression becomes:

$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}} ,$$

where the internal reference factor is B (which is a percentage of V_{dd}, and A is 1-B.

But by the end of one complete cycle, the overall effect is similar to that when the internal reference was at 50% of Vdd, i.e., the result is still V_{INT}=Q_{S}/C_{INT}. Hence this scheme is independent of internal voltage reference.

For example, if the internal reference voltage is 60% of Vdd, then A is 40% and B is 60% and the relationship resolves as:

$${V}_{INT} = \frac{0.4 * ( {Q}_{S} + {Q}_{M} ) - {Q}_{M} - ( 0.6 * ( - {Q}_{S} - {Q}_{M} ) )}{{C}_{INT}} = \frac{{Q}_{S}}{{C}_{INT}}$$

There are various ways to ensure that the guarding waveform is such that only one edge of the guarding signal lies within an integration phase. One way is to use a cyclo-stationary method. Another is to use a non-cyclo-stationary method.

In a cyclo-stationary method, timings of the various transitions of the guarding waveform are fixed with respect to the sensing waveform. Thus the guarding waveform can be derived from the sensing waveform, or the states of the various phases of the sensing waveform (i.e., the charge phase φ1, the positive integration phase φ2, the discharge phase φ3, and the negative integration phase φ4). To that end a counter or clock is used to determine the elapse of each phase of the sensing cycle. In essence, When the counter or clock reaches a desired value for a given phase, the sensing cycle transitions to the next phase. This process is repeated until the system is shut down or is put in a standby or sleep mode.

In a specific implementation, the phases φ1, φ2, φ3, and φ4 can have assigned to them a number of clock cycles M, O, P, and Q, respectively. The sensing signal generator can be a state machine, with each phase being a state of the machine. A signal or variable representative of the phase/state of the machine can then be generated. Then the guarding waveform can be generated by delaying generation of the guarding waveform by one clock cycle such that a desired guard waveform transition occurs within the desired phase.

For example, in the case off a positive guarding scheme, the guard waveform can be derived by decoding when the phase/state signal is in phase 2, the positive integration phase, and delaying the generation of the guard waveform by one clock cycle from phase 2. The width of the guard signal is such that the next transition will occur in phase 3 or within a delay from the beginning of phase 3.

In a touch sensing system employing a Sigma-Delta method or multi-cycle integration approach, the final sensing result is only obtained after a predetermined number of cycles, e.g., N cycles, where N is a programmable number. Such sensing systems are also called over-sampling systems, where N specifies a factor by which the signal is over-sampled. This need to use N cycles provides for flexibility in the guarding scheme.

In that regard, a sensor being sensed is either connected to Vdd or Ground and then connected to the charge integrator, which sets the voltage of the sensor to the reference voltage V_{ref}. Then, the per cycle contribution from mutual capacitance is Q_{M}=V_{ref}*C_{M}. In this case, V_{ref} is less than V_{dd} and, hence, even if one employs one guard waveform transition per cycle, it will result in over-guarding. Under these conditions, the above described implementation will be effective.

When the sensing system is operating such that the sensor is discharged and connected to a charge integrator with reference voltage V_{ref}, the sensing waveform will transition from Ground to V_{ref} and back to ground on every cycle. This scheme uses unipolar signaling and hence will not have a charge phase and a positive integration phase. Instead it will only have the discharge phase and the negative integration phase.

In such sensing system, it is possible to completely cancel the mutual capacitance contribution as long as: Q_{M,total}=NQ_{M}−MQ_{G}, where Q_{M}=V_{ref}*C_{M}, Q_{G}−V_{dd}*C_{M}, and M=N*V_{ref}/V_{dd}. Thus the sensing system needs to make sure it guards only M out of N sensing cycles. In this implementation, there will be some cycles which are not guarded, and hence all of the sensing cycles are not the same. As a result, this is a non-cyclo-stationary implementation.

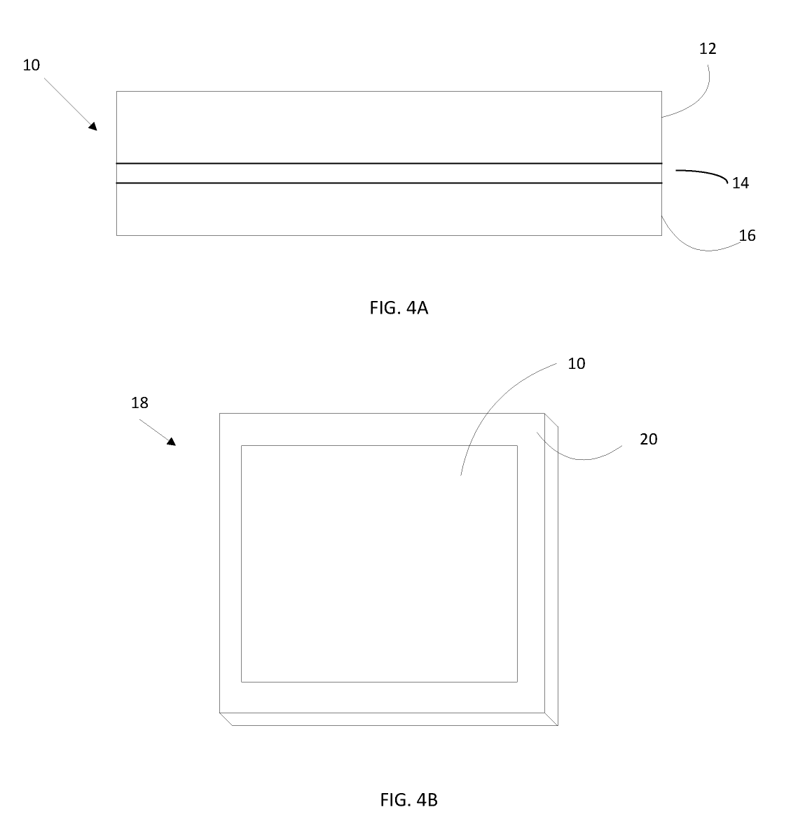

In FIG. 4A, there is illustrated in schematic cross section a touch sensor device 10 that can be driven in accordance with principles disclosed herein. The device 10 includes a touch substrate 12 layered onto a display substrate 14, which is layered on a processing substrate 16. Preferably, the touch sensor substrate carries touch detection sensors or elements while the display substrate 14 carries suitable display elements such organic-electroluminscent display (OLED) elements or liquid crystal display (LCD) elements. The processing substrate 16 carries any necessary processing circuitry to drive the touch sensors and display elements. All three of the substrates can be any of the known flexible substrates. The touch substrate 12 and the display substrate 14 can be integrated as an in-cell or on-cell touch/display device.

The touch substrate 12 is intended to be representative of any suitable combination of layers making up a capacitive touch sensing device, including any protective layers that might be desired. Such other layers are well known.

In FIG. 4B there is illustrated a tablet device 18, as representative of any device incorporating both touch and display functionality in a single device. The device 18 includes the touch sensor device 10 house within a suitable housing 20.

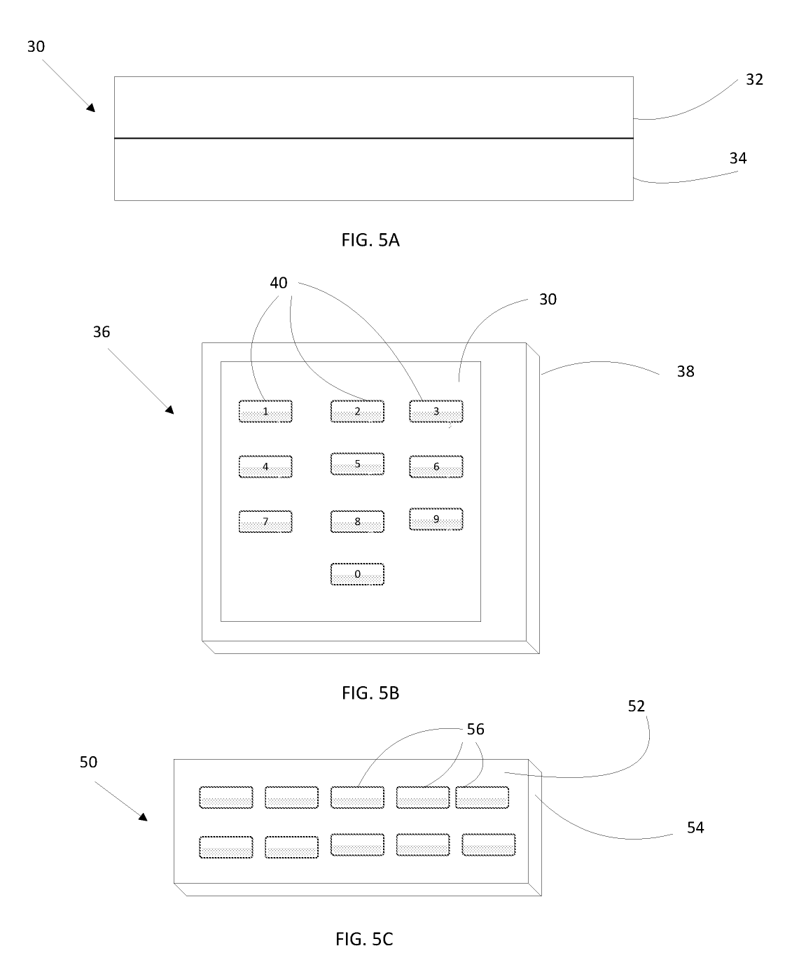

In FIG. 5A there is illustrated in schematic cross section a keypad device 30 in which the disclosed guarding scheme can be used. The keypad include a touch substrate 32 and a processing substrate 34. The touch substrate 32 includes sensor elements with appropriate indicia of numbers, letter or symbols associated therewith. The processing substrate 34 includes appropriate circuitry for processing drive signals and sense signals to and from the touch substrate 32.

In FIG. 5B there is illustrated an example of a keypad apparatus 36 including the keypad device 30 in a housing 38. The standard telephone indicia 40 are incorporated into the keypad device 30 so that the keypad apparatus 36 can serve for numerical input. However, as indicated above, the indicia can be of any type of symbol.

In FIG. 5C there is illustrated a keyboard style apparatus 50 incorporating a keypad device 52 within a housing 54. The keypad device 52 similarly includes various indicia 56, such as, for example, those relating to a QWERTY keyboard. This illustrates yet another device to which the present disclosure can be applied.

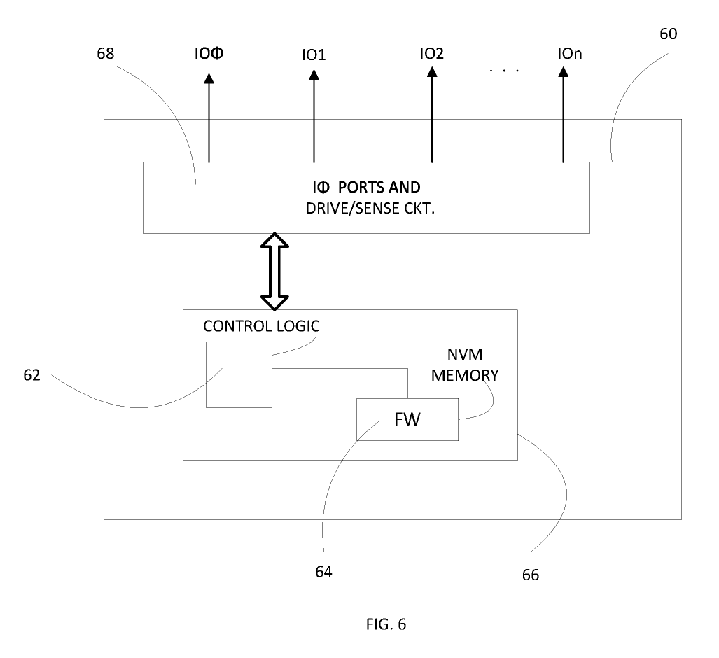

In FIG. 6, there is illustrated a device 60 that can be programmed with logic to effect a driving scheme in accordance with principles disclosed herein. As illustrated, the device 60 can include at least one core 62 that executes logic provided in at least one memory block 64, preferably a non-volatile memory. The logic can be in any suitable form in including software stored in the memory module or firmware. The core 62 and memory block 64 can be integrated in a single device or chip 66 or provided as separate devices. As alluded to above, more than one core and more than one memory block can be employed.

In FIG. 6, the device 60 also includes at least one communications module 68 via which input and output signals can be communicated. The signals might be the sensing signals and guarding signals, or signals controlling the communication of those signal by other modules. The integration or segregation of such signals is known or easily implemented. The communications module is driven so as to drive the input and output signals with correct timing as shown in the in the waveforms of FIGS. 3A to 3C.

Alternatively, the chip 66 could comprise a state machine made of hardwired logic devices that implement the desired control scheme. In that case, the core 62 and 64 would be replaced by equivalent hardware logic circuitry, which equivalent circuitry is known or easily determined.

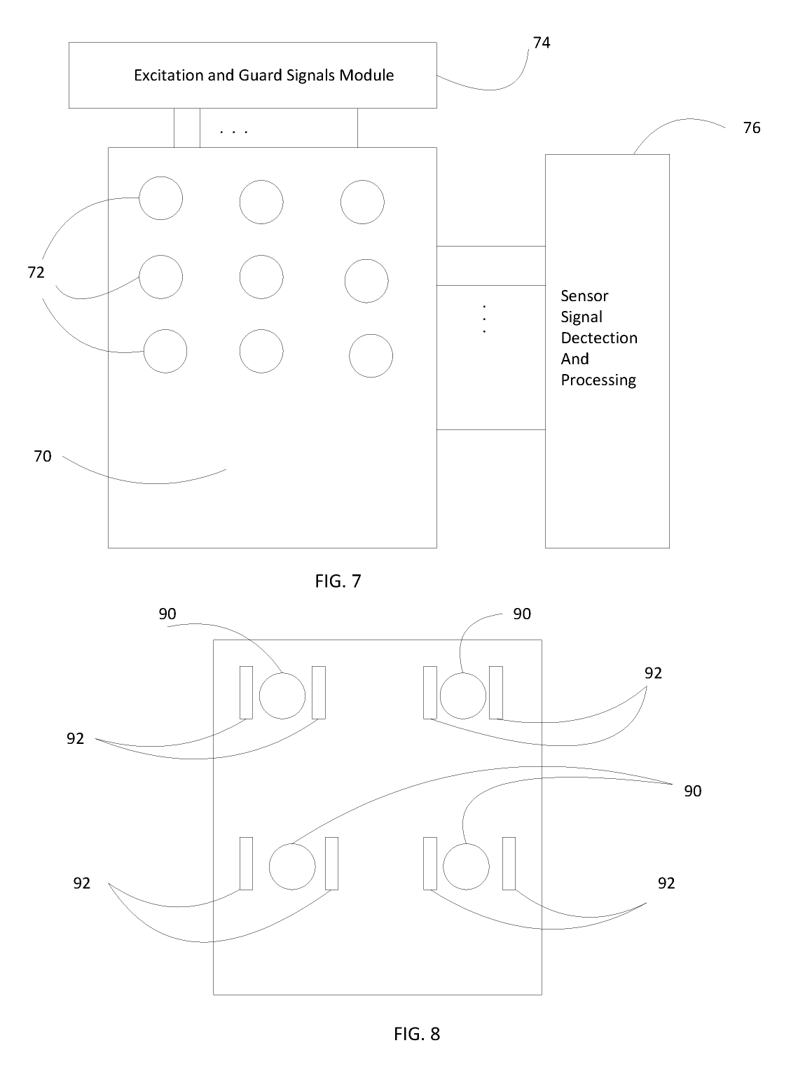

In FIG. 7, there is illustrated a sensor array 70 comprised of nine exemplary capacitive sensors 72. The sensors 42 are shown as circular, but can be of any suitable shape.

In FIG. 7, the array 70 is shown in communication with an excitation signals module 74 and a sensor signal detection and processing module 76. These modules 74 and 76 are illustrative of the various modules that ultimately generate, process and manage the excitation, guarding and sense signals described herein.

In FIG. 8, there is illustrate another sensor array 90 with sensors 92, each having two adjacent or neighboring conductive elements 94. touch screen 50 comprised of four exemplary capacitive sensors 52, each having adjacent (i.e., neighboring conductive elements 54 that can be driven in accordance with the guarding scheme disclosed herein.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of sensing self-capacitance with guarding comprising:
providing a set of capacitive sensors and conductive elements arranged in arbitrary fashion to form a touch panel;
providing a device for measuring total capacitance of each sensor in a sequence; and
guarding adjacent conductive elements using square wave guarding signal such that mutual capacitance from each sensor or conductive element to every sensor is completely eliminated.

2. The method of claim 1, wherein one edge of the square wave guarding signal occurs during one of two active phases of a sensing cycle and another edge occurs during an inactive phase between the two active phases such that only the one of the edges of square wave guarding signal is effective.

3. The method of claim 1, wherein a time-averaged charge sensed due to guarding adjacent sensors is completely equal and opposite to that from mutual capacitance due to sensing.

4. The method in claim 1, wherein the device for measuring total capacitance at least comprises:
a sensor driving circuit;
an integrator to measure incoming or outgoing total charge; and
an analog to digital converter (ADC) to convert measured analog signal into digital data.

5. The method of claim 1, wherein the conductive elements are capacitive sensor.

6. The method of claim 4, wherein an output V_{INT} of the integrator adheres to the following relationship:
$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, B is an internal reference factor of system power supply, and A is 1-B.

7. A processor device comprising hardware or software logic to effect the process steps of:
causing generation of a square-wave guarding signal with rising and falling edges as transitions;
during a sensing cycle of a capacitive sensor including positive and negative phases, causing a capacitive sensor of interest to be guarded by applying the guarding signal to at least one conductive element adjacent to the capacitive sensor of interest only during one of the phases.

8. The processor device of claim 7, wherein the logic causes the capacitive sensor of interest to be sensed the interval between the positive and negative charging phases, and the guarding signal to be controlled to have only one transition to occur when the capacitive sensor of interest is being sensed during the sensing cycle.

9. The processor device of claim 7, wherein the adjacent conductive element is another capacitive sensor.

10. The processor device of claim 7, wherein the logic causes the one of the edges of the guarding signal to occur prior to one of the phases of the capacitive sensor of interest and the other edge of the guarding signal to occur during the other phase of the capacitive sensor of interest.

11. The processor device of claim 7, wherein an output V_{INT} of the integrator adheres to the following relationship:
$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, B is an internal reference factor of system power supply, and A is 1-B.

12. A method of driving a capacitive touch sensing system, comprising:
generating a square-wave guard waveform with rising and falling edges as transitions;
during a sensing cycle including positive and negative charging phases, guarding a capacitive sensor of interest by applying the guard waveform to at least one conductive element adjacent to the capacitive sensor of interest only during the positive charging phase; and
integrating by an integrator a voltage of the capacitive sensor of interest during the sensing cycle.

13. The method of claim 12, wherein the capacitive sensor of interest is driven by a sensor signal with a mid voltage between the positive and negative charging phases, and the guard signal is controlled to have only one transition to occur when the capacitive sensor of interest is at mid voltage during the sensing cycle.

14. The method of claim 12, wherein the adjacent conductive element is another capacitive sensor.

15. The method of claim 12, wherein the rising edge of the guard waveform occurs prior to the positive charge phase of the capacitive sensor of interest, when the sensor of interest is not connected to an integrator, and the falling edge of the guard signal occurs prior to the negative charging phase of the capacitive sensor of interest.

16. The method of claim 12, wherein an output V_{INT} of the integrator adheres to the following relationship:
$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, and an internal reference factor is ½.

17. The method of claim 12, wherein an output V_{INT} of the integrator adheres to the following relationship:
$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, B is an internal reference factor of system power supply, and A is 1-B.

18. A processor device comprising logic to effect the process steps of:
causing generation of a square-wave guard waveform with rising and falling edges as transitions;
during a sensing cycle of a capacitive sensor including positive and negative charging phases, causing a capacitive sensor of interest to be guarded by applying the guard waveform to at least one conductive element adjacent to the capacitive sensor of interest only during the positive charging phase; and
integrating with an integrator a voltage of the capacitive sensor of interest during the sensing cycle.

19. The processor device of claim 17, wherein the logic causes the capacitive sensor of interest to be driven by a sensor signal with a mid voltage between the positive and negative charging phases, and the guard signal to be controlled to have only one transition to occur when the capacitive sensor of interest is at mid voltage during the sensing cycle.

20. The processor device of claim 18, wherein the adjacent conductive element is another capacitive sensor.

21. The processor device of claim 18, wherein the logic causes the rising edge of the guard waveform to occur prior to the positive charge phase of the capacitive sensor of interest, when the sensor of interest is not connected to an integrator, and the falling edge of the guard signal to occur prior to the negative charging phase of the capacitive sensor of interest.

22. The processor device of claim 18, wherein an output V_{INT} of the integrator adheres to the following relationship:
$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, and an internal reference factor is ½.

23. The processor device of claim 18, wherein an output V_{INT} of the integrator adheres to the following relationship:
$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, B is an internal reference factor of system power supply, and A is 1-B.

24. A non-transitory storage device including machine readable or implementable logical instructions that when executed by the machine cause the machine to effect the process steps of:
causing generation of a square-wave guard waveform with rising and falling edges as transitions;
during a sensing cycle of a capacitive sensor including positive and negative charging phases, causing a capacitive sensor of interest to be guarded by applying the guard waveform to at least one conductive element adjacent to the capacitive sensor of interest only during the positive charging phase; and
integrating with an integrator a voltage of the capacitive sensor of interest during the sensing cycle.

25. The non-transitory storage device of claim 24, wherein the logical instructions cause the capacitive sensor of interest to be driven by a sensor signal with a mid voltage between the positive and negative charging phases, and the guard signal to be controlled to have only one transition to occur when the capacitive sensor of interest is at mid voltage during the sensing cycle.

26. The non-transitory storage device of claim 24, wherein the adjacent conductive element is another capacitive sensor.

27. The non-transitory storage device of claim 24, wherein the logical instructions cause the rising edge of the guard waveform to occur prior to the positive charge phase of the capacitive sensor of interest, when the sensor of interest is not connected to an integrator, and the falling edge of the guard signal to occur prior to the negative charging phase of the capacitive sensor of interest.

28. The non-transitory storage device of claim 24, wherein an output V_{INT} of the integrator adheres to the following relationship:
$${V}_{INT} = \frac{0.5 * ( {Q}_{S} + {Q}_{M} ) - {Q}_{M} - ( 0.5 * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, and an internal reference factor is ½.

29. The non-transitory storage device of claim 24, wherein an output V_{INT} of the integrator adheres to the following relationship:
$${V}_{INT} = \frac{A * ( {Q}_{S} + {Q}_{M} ) - {Q}_{M} - ( B * ( - {Q}_{S} - {Q}_{M} ) )}{{C}_{INT}} = \frac{{Q}_{S}}{{C}_{INT}}$$
where,
Q_{S} is a charge on the capacitive sensor of interest, Q_{M} is a charge resulting from one or more mutual capacitances affecting the capacitive sensor of interest, C_{INT} is a capacitance of the integrator, B is an internal reference factor of system power supply, and A is 1-B.
